(19) United States
(12) Patent Application Publication
(10) Pub. No.: US 2010/0003523 A1
(43) Pub. Date: Jan. 7, 2010

(54) Coated Film for Insert Mold Decoration, Methods for Using the Same, and Articles Made Thereby

(75) Inventors: Andrei Sharygin, Mount Vernon, IN (US); David Clinnin, Newburgh, IN (US); Kwan Hongladarom, Mount Vernon, IN (US); Jamuna Chakravarti, Evansville, IN (US); Keshav Gautam, Evansville, IN (US); Michael Matthew Laurin, Pittsfield, MA (US)

Correspondence Address: CANTOR COLBURN, LLP, 20 Church Street, 22nd Floor, Hartford, CT, 06103, US

(73) Assignee: SABIC INNOVATIVE PLASTICS IP B.V., Bergen op Zoom (NL)

(21) Appl. No.: 12/166,784

(22) Filed: Jul. 2, 2008

(51) Int. Cl. B32B 27/08

(52) U.S. Cl. 428/412; 428/423.1; 264/269

(57) ABSTRACT

A coated thermoplastic film can be subjected to printing to obtain a decorative film, preformed (for example, thermoformed), and then inserted into a mold that has the configuration of the preformed decorative film. A base polymeric structure comprising a polymer such as a polycarbonate or blend thereof can be injection molded to the exposed surface of the preformed decorative film. The molded structure has various applications such as cell phones or other electronic devices, automotive vehicles, appliances, display panels, lenses, etc. A process for making the molded article is also described. The coating for the coated thermoplastic film can be made from a UV-curable composition and can provide superior embossing and thermoformability, hardness, and adhesion, while providing enhanced chemical, scratch and abrasion resistance.

### FIELD OF INVENTION

This disclosure relates to a coated film comprising a UV-cured composition that can be used for in-mold decoration.

### BACKGROUND OF THE INVENTION

Decorating a three-dimensional article via in-mold decoration (IMD) or insert mold decoration involves inserting a decorative film into a molding tool in combination with a molten base polymer during an injection molding cycle. The decorative film is then bonded with or encapsulated by the molten base polymer, after the injection molding cycle is complete, to obtain an injection molded article or finished part having the desired decoration. The decoration for the finished part can either be exposed to the environment as “first surface decoration” and/or encapsulated between the substrate of the decorative film and the injected material as “second surface decoration.” Thus, the decorative film becomes a permanent fixture of the finished part. The film can act as an aesthetic effect carrier and/or as a protective layer for the base polymer, the ink, or both. The term “decorative” or “decoration” herein refers to surface printing or marking of an aesthetic, functional and/or informational nature that is printed on the decorative film including, for example, symbols, logos, designs, colored regions, and/or alphanumeric characters.

The decorative film can be printed with ink, specifically formable and high temperature inks. The film can then be formed on a tool into a three-dimensional shape that corresponds to the three-dimensional shape desired for the injection molded article.

Such processes are disclosed in U.S. Pat. No. 6,117,384 to Laurin et al., which describes a process wherein a colored decorated film is incorporated with a molten resin injected behind the film to produce a permanently bonded three-dimensional piece. U.S. Pat. No. 6,458,913 to Honigfort and U.S. Pat. No. 6,682,805 to Lilly also describe insert mold decorative films and articles. Lilly describes a multi-layer thermoplastic printable film comprising a thermoplastic film substrate having laminated to one surface a fluoride polymer in order to improve the birefringence and other properties of the film, including chemical resistance.

Increasingly it is desired that the exposed surface of a decorative film be resistant to scratch, abrasion, and chemical attacks. A cost-effective method to improve the surface characteristics of the film is to coat the film with a coating that provides the desired performance properties. For example, Sabic Innovative Plastic's LEXAN® HP92S polycarbonate is coated with a propriety hard coat specifically to improve surface durability against scratch and abrasion. The hard coat forms a bonded layer on the surface of the film, typically from 3 to 18 micrometers. The coating layer, however, is more brittle than desirable and, therefore, can limit the ability of the hard-coated film to be shaped or embossed.

In one approach, a coated polycarbonate film is only partially cured during the initial phase of the film production. Partially curing the film allows the hard coat to remain soft and compliant during thermoforming to shape the film. After the film had been thermoformed and put through an IMD process, the resulting article is then exposed to ultraviolet (UV) light for post-curing to achieve the desired surface hardness. This approach has a number of drawbacks. The partially cured film can only be exposed to special lighting. Normal lighting has a UV component that can cause a premature curing of the partially cured film. The soft surface of the partially cured film is prone to damage while it is being processed through the printing, thermoforming, and in-mold decoration injection steps, leading to a high level of yield loss. It is desirable to have a film with a hard coat already cured so that the coated film is robust to handling and does not need special lighting requirements.

In an alternative approach, an IMD three-dimensional article could also be subjected to post-production coating and subsequent curing. However, this added step in the manufacturing process can be expensive, time consuming and not provide a level of coating control, uniformity, and quality comparable to that of a pre-coated film. Post-production coating and subsequent curing can also need to be specific for a particular article, and some articles, due to their size or geometry, can need special handling requirements. A pre-coated film would eliminate these drawbacks or problems.

### SUMMARY OF INVENTION

A coated thermoplastic film is disclosed comprising a single or multilayer film substrate having a coating thereon obtained by applying to one surface of the film substrate a coating composition comprising: a polymeric film substrate; and a coating formed from a coating composition that comprised a urethane acrylate having a functionality of greater than or equal to 2.5 to 6.0 acrylate functional groups; and an acrylate monomer having at least one acrylate functional group; wherein the coating composition is subsequently cured; and wherein acrylate refers to both acrylate and methacrylate groups.

An optional polymerization initiator to promote polymerization of the (meth)acrylate components can be included in the coating composition.

In one embodiment, the surface of the polycarbonate film substrate opposite the coating is subjected to printing (decorating) and then shaped, for example by cold forming or thermoforming, to form a three-dimensional decorative film. In some cases, an unshaped or flat decorative film is sufficient. A specific method of making the coated polycarbonate film is also disclosed.

Also disclosed is a molded article comprising the decorative film and an injection molded base polymeric structure to which the decorative film is bonded.

Finally, a method of molding an article is disclosed comprising placing the decorative film into a mold and injecting a resin, referred to as the base polymer composition, into the mold cavity space behind the decorative film, whereby the decorative film and the injection molded resin form a single molded part.

### DETAILED DESCRIPTION OF THE INVENTION

As indicated above, a coated thermoplastic film is disclosed comprising a polycarbonate (PC) film substrate having a coating made by applying to one side of the PC film a coating composition comprising urethane acrylate containing 2.5 to 6.0 acrylate functional groups on average. More specifically, the urethane acrylate contains, on average, 2.5 to 5.5, more specifically 3.0 to 4.5 acrylate functional groups, still more specifically 3.0 to 4.0 acrylate functional groups.

The coating composition further comprises a acrylate monomer (i.e., meth(acrylate) monomer) containing at least one acrylate functional group, specifically 1 to 5, more specifically 2 to 3.

The coating composition further comprises an optional polymerization initiator to promote polymerization of the acrylate components. Suitable polymerization initiators include photoinitiators that promote polymerization of the components upon exposure to ultraviolet radiation.

In one embodiment, the urethane acrylate in the coated thermoplastic film has an elongation percent at break of at least 10 according to ASTM D882, specifically an elongation percent at break of 15 to 100. Furthermore, the urethane acrylate can have a tensile strength of 1000 to 5000 psi and a glass transition range of 10 to 50° C.

The coating composition applied to the film substrate comprises a urethane acrylate in the amount of 20% to 90% by weight, specifically 35% to 75% by weight, more specifically 55% to 65% by weight; acrylate monomer present in the amount of 10% to 80% by weight, specifically 25% to 65% by weight, more specifically 35% to 45% by weight; and optional polymerization initiator present in the amount of 0% to 10% by weight, specifically 0.1% to 5% by weight, more specifically 0.5% to 3% by weight, wherein weight is based on the total weight of the coating composition.

The surface of the polycarbonate film substrate opposite the coating can be subsequently printed or decorated, for example, with markings selected from the group consisting of alphanumerics, graphics, symbols, indicia, logos, aesthetic designs, multicolored regions, and a combination comprising at least one of the foregoing. In some cases, the coated PC film can be used solely as a protective film optionally shaped, without printing. The coated PC film can also be subjected to printing with ink and shaped into a three-dimensional film for specific applications.

If the final piece is three dimensional, there are various techniques for forming three-dimensional IMD parts. For example, for parts having a draw depth greater than or equal to 1 inch (2.54 cm), thermoforming or variations of thermoforming can be employed. Variations include but are not limited to vacuum thermoforming, zero gravity thermoforming, plug assist thermoforming, snap back thermoforming, pressure assist thermoforming, and high pressure thermoforming. For parts containing detailed alphanumeric graphics or draw depths less than 1 inch (2.54 cm), cold forming techniques are exemplary. These include but are not limited to embossing, matched metal forming, bladder or hydro forming, pressure forming, or contact heat pressure forming.

If less than 20 percent by weight of the urethane acrylate component is used, flexibility and overall toughness can suffer. If more than 90 percent by weight is used, by weight of the total coating composition, the viscosity of the composition can be undesirably high and, thus, make application of the coating composition difficult.

In one embodiment, the urethane acrylate can include a compound produced by reacting an aliphatic isocyanate with an oligomeric diol such as a polyester diol or polyether diol to produce an isocyanate capped oligomer. This oligomer is then reacted with hydroxy ethyl acrylate to produce the urethane acrylate.

The urethane acrylate oligomer specifically can be an aliphatic urethane acrylate, for example, a wholly aliphatic urethane (meth)acrylate oligomer based on an aliphatic polyol, which is reacted with an aliphatic polyisocyanate and acrylated. In one embodiment, it can be based on a polyol ether backbone. For example, the an aliphatic urethane acrylate oligomer can be the reaction product of (i) an aliphatic polyol; (ii) an aliphatic polyisocyanate; and (iii) an end capping monomer capable of supplying reactive terminus. The polyol (i) can be an aliphatic polyol, which does not adversely affect the properties of the composition when cured. Examples include polyether polyols; hydrocarbon polyols; polycarbonate polyols; polyisocyanate polyols, and mixtures thereof.

A representative polyether polyol is based on a straight chain or branched alkylene oxide of one to about twelve carbon atoms. The polyether polyol can be prepared by any method known in the art. It can have, for example, a number average molecular weight (Mₙ), as determined by vapor pressure osmometry (VPO), per ASTM D-3592, sufficient to give the entire oligomer based on it a molecular weight of not more than about 6000 Daltons, specifically not more than about 5000 Daltons, and more specifically not more than about 4000 Daltons. Such polyether polyols include but are not limited to polytetramethylene polyol, polymethylene oxide, polyethylene oxide, polypropylene oxide, polybutylene oxide, and a mixture comprising at least one of the foregoing.

Representative hydrocarbon polyols which can be used include but are not limited to those based on a linear or branched hydrocarbon polymer of 600 to 4,000 number average molecular weight such as fully or partially hydrogenated 1,2-polybutadiene; 1,2-polybutadiene hydrogenated to an iodine number of 9 to 21; and fully or partially hydrogenated polyisobutylene. Unsaturated hydrocarbon polyols are less desirable because the oligomers made from them, when cured, are susceptible to oxidation.

Representative polycarbonate polyols include but are not limited to the reaction products of dialkyl carbonate with an alkylene diol, optionally copolymerized with alkylene ether diols.

In one embodiment, the polyisocyanate component (ii) can be essentially non-aromatic, less than five percent, specifically less than one percent, more specifically zero weight percent, based upon a total weight of the polyisocyanate component. For example, non-aromatic polyisocyanates of 4 to 20 carbon atoms can be employed. Saturated aliphatic polyisocyanates include, but are not limited to, isophorone diisocyanate; dicyclohexylmethane-4,4′-diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,9-nonamethylene diisocyanate; 1,10-decamethylene diisocyanate; 2,2,4-trimethyl-1,5-pentamethylene diisocyanate; 2,2′-dimethyl-1,5-pentamethylene diisocyanate; 3-methoxy-1,6-hexamethylene diisocyanate; 3-butoxy-1,6-hexamethylene diisocyanate; omega, omega′-dipropylether diisocyanate; 1,4-cyclohexyl diisocyanate; 1,3-cyclohexyl diisocyanate; trimethylhexamethylene diisocyanate; and a mixtures comprising at least one of the foregoing.

The reaction rate between the hydroxyl-terminated polyol and a diisocyanate can be increased by use of a catalyst in the amount of 100 to 200 ppm by weight. Catalysts include but are not limited to dibutyl tin dilaurate, dibutyl tin oxide, dibutyl tin di-2-hexoate, stannous oleate, stannous octoate, lead octoate, ferrous acetoacetate, and amines such as triethylamine, diethylmethylamine, triethylenediamine, dimethylethylamine, morpholine, N-ethyl morpholine, piperazine, N,N-dimethyl benzylamine, N,N-dimethyl laurylamine, and a mixture comprising at least one of the foregoing.

The end capping monomer (iii) can be one, which is capable of providing acrylate or methacrylate termini. Exemplary hydroxyl-terminated compounds which can be used as the end capping monomers include but are not limited to hydroxyalkyl acrylates or methacrylates such as hydroxyethyl acrylate, hydroxyethyl methacrylate, hydroxypropyl acrylate, hydroxypropyl methacrylate, hydroxybutyl acrylate, hydroxybutyl methacrylate, and the like. A specific exemplary end capping monomer is hydroxyethyl acrylate or hydroxyethyl methacrylate.

The functionality of the urethane acrylate is the number of acrylate or methacrylate termini in the oligomer. More specifically, urethane acrylates that are trifunctional acrylates can be used, meaning that the functionality is 3 on average to within the closest integer. As used herein, the term “trifunctional aliphatic urethane acrylate” or triacrylate” will refer to oligomers in which the number of acrylate groups are in the range of about 2.5 to 3.5 on average.

Some commercially available oligomers which can be used in the coating composition can include, but are not limited to, trifunctional aliphatic urethane acrylates that are part of the following families: the PHOTOMER® Series of aliphatic urethane acrylate oligomers from Cognis Corporation, Cincinnati, Ohio; the Sartomer CN Series of aliphatic urethane acrylate oligomer from Sartomer Company, Exton, Pa.; the Echo Resins Series of aliphatic urethane acrylate oligomers from Echo Resins and Laboratory, Versailles, Mo.; the BR Series of aliphatic urethane acrylates from Bomar Specialties, Winsted, Conn.; and the EBECRYL® Series of aliphatic urethane acrylate oligomers from UCB Chemicals Corporation, Smyrna, Ga.; In an exemplary embodiment, the aliphatic urethane acrylate is PHOTOMER 6892 oligomer.

Another component of the coating composition is a reactive monomer diluent having one or more acrylate or methacrylate moieties per monomer molecule, and which is one which results in a hard curing (high modulus) coating, of suitable viscosity for application conditions. The monomer is capable of lowering the viscosity of the overall liquid composition to within the range of about 10 to about 10,000 cps (centipoises) at 25° C., specifically about 50 to 2,000 cps, and more specifically 100 to 1,000 cps, as measured by a Brookfield Viscometer, Model LVDV-II+, spindle CPE-51, at 25° C. If a viscosity higher than about 10,000 cps results, the coating composition can be used if certain processing modifications are effected, e.g., increased heating of the dies through which the coating composition is applied

The reactive acrylate monomer diluent can be mono-, di-, tri-, tetra- or penta functional. In one embodiment, di-functional monomers are employed for the desired flexibility and adhesion of the coating. The monomer can be straight-or branched-chain alkyl; cyclic; or partially aromatic. The reactive monomer diluent can also comprise a combination of monomers that, on balance, result in a suitable viscosity for coating composition, which cures to form a hard, flexible material having the desired properties.

The reactive monomer diluent, within the limits discussed above, can include monomers having a plurality of acrylate or methacrylate moieties. These can be di-, tri-, tetra-or penta-functional, specifically difunctional, in order to increase the crosslink density of the cured coating and therefore to increase modulus without causing brittleness. Examples of polyfunctional monomers include, but are not limited, to C₆-C₁₂ hydrocarbon diol diacrylates or dimethacrylates such as 1,6-hexanediol diacrylate and 1,6-hexanediol dimethacrylate; tripropylene glycol diacrylate or dimethacrylate; neopentyl glycol diacrylate or dimethacrylate; neopentyl glycol propoxylate diacrylate or dimethacrylate; neopentyl glycol ethoxylate diacrylate or dimethacrylate; 2-phenoxylethyl (meth)acrylate; alkoxylated aliphatic (meth)acrylate; polyethylene glycol (meth)acrylate; lauryl (meth)acrylate, isodecyl (meth)acrylate, isobornyl (meth)acrylate, tridecyl (meth)acrylate; and mixtures comprising at least one of the foregoing monomers. In one embodiment, the specific monomer is 1,6-hexanediol diacrylate (HDODA), alone or in combination with another monomer.

Another component of the coating composition can be an optional photoinitiator. The necessity for this component depends on the envisioned mode of cure of the coating composition: if it is to be ultraviolet cured, a photoinitiator is needed; if it is to be cured by an electron beam, the material can comprise substantially no photoinitiator.

In the ultraviolet cure embodiment, the photoinitiator, when used in a small but effective amount to promote radiation cure, can provide reasonable cure speed without causing premature gelation of the coating composition. Further, it can be used without interfering with the optical clarity of the cured coating material. Still further, the photoinitiator can be thermally stable, non-yellowing, and efficient.

Photoinitiators can include, but is not limited to, the following: hydroxycyclohexylphenyl ketone; hydroxymethylphenylpropanone; dimethoxyphenylacetophenone; 2-methyl-1-[4-(methylthio)phenyl]-2-morpholinopropanone-1; 1-(4-isopropylphenyl)-2-hydroxy-2-methylpropan-1-one; 1-(4-dodecylphenyl)-2-hydroxy-2-methylpropan-1-one;4-(2-hydroxyethoxy) phenyl-(2-hydroxy-2-propyl)ketone; diethoxyacetophenone; 2,2-di-sec-butoxyacetophenone; diethoxy-phenyl acetophenone; bis(2,6-dimethoxybenzoyl)-2,4-, 4-trimethylpentylphosphine oxide; 2,4,6-trimethylbenzoyldiphenylphosphine oxide; 2,4,6-trimethylbenzoylethoxyphenylphosphine oxide; and mixtures of these.

Particularly suitable photoinitiators include phosphine oxide photoinitiators. Examples of such photoinitiators include the IRGACURE™ and DAROCUR™ series of phosphine oxide photoinitiators available from Ciba Specialty Chemicals; the LUCIRIN™ series from BASF Corp.; and the ESACURE™ series of photoinitiators from Lamberti, s.p.a. Other useful photoinitiators include ketone-based photoinitiators, such as hydroxy- and alkoxyalkyl phenyl ketones, and thioalkylphenyl morpholinoalkyl ketones. Also suitable are benzoin ether photoinitiators. Specific exemplary photoinitiators are bis(2,4,6-trimethylbenzoyl)-phenylphosphine oxide or 2-hydroxy-2-methyl, such as are supplied by Ciba-Geigy Corp., Ardsley, N.Y., as DAROCUR® 1173 and IRGACURE® 819, respectively.

The photoinitiator can be chosen such that curing energy of less than 2.0 J/cm², and specifically less than 1.0 J/cm², is required, when the photoinitiator is used in the designated amount.

The polymerization initiator can include peroxy-based initiators that can promote polymerization under thermal activation. Examples of useful peroxy initiators include benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, alpha,alpha′-bis(t-butylperoxy-m-isopropyl)benzene, 2,5-dimethyl-2,5-di(t-butylperoxy)hexane, dicumylperoxide, di(t-butylperoxy isophthalate, t-butylperoxybenzoate, 2,2-bis(t-butylperoxy)butane, 2,2-bis(t-butylperoxy)octane, 2,5-dimethyl-2,5-di(benzoylperoxy)hexane, di (trimethylsilyl)peroxide, trimethylsilylphenyltriphenylsilyl peroxide, and the like, and combinations comprising at least one of the foregoing polymerization initiators.

The composition can optionally further comprise an additive selected from flame retardants, antioxidants, thermal stabilizers, ultraviolet stabilizers, dyes, colorants, anti-static agents, and the like, and a combination comprising at least one of the foregoing additives, so long as they do not deleteriously affect the polymerization of the composition. Selection of particular additives and their amounts can be performed by those skilled in the art.

The coating composition can provide a hard coat having advantageous properties, as described in more detail in the examples below. In one embodiment, the coating composition can have a Tabor Abrasion Delta Haze, as measured after 100 cycles using 500 gram load and CS-10F Taber abrasion wheel under ASTM D1044-08 of less than or equal to 5 percent, more specifically less than or equal to 3 percent. The hard coat can pass a Mandrel Bend of not more than 1 inch, specifically not more than ½ inch, more specifically not more than ⅜ inch, and still more specifically not more than ⅛ inch. The hard coat can also have a minimum adhesion of 5 B as measure by ASTM D3002-07 and a minimum pencil hardness of HB as measured using a Elcometer® 3086 motorized pencil hardness tester (Elcometer, Inc.; Rochester Hills, Mich.) at 500 g load and Mitsubishi pencils (Mitsubishi Pencil Co Ltd) by ASTM D3363-05.

The polymeric film substrate can comprise various polymers. For example, the film substrate can comprise polycarbonates, polyesters (e.g., poly(ethylene terephthalate), acrylates (e.g., poly(methyl methacrylate)), polystyrenes (e.g., polyvinyl chloride polystyrene, polyvinylidene chlorides, polyolefins (e.g., polypropylene, polyethylene), fluoride resins, polyamides, polyphenylene oxides, and combinations comprising at least one of the foregoing. In one embodiment, the polymer film substrate can specifically comprise polycarbonate.

Use of modifiers for gaining adhesion to various substrates are known to those skilled in the art. Monomers selected for their high diffusion rates into said substrates can be one such modification route for improved adhesion. Solvent modifications of can also impart improved adhesion as solvent modifiers can promote higher diffusion by opening the surface structure of the film substrate. Secondary surface treatments of the film substrate can also be employed for improvements in adhesion by an increase in surface energy through flame, corona, plasma, and ozone treatment of the film substrate prior to application of coatings. Adhesion to the film substrate surface can also be improved via use of coupling agents or adhesion promoters such as silanes applied to the surface of the film substrate. These modifications are known to assist in wetting rates for the applied coatings and can increase the amount of diffusion prior to cure.

In one embodiment, the polycarbonate film substrate comprises polycarbonate made by the polymerization of dimethyl bisphenol cyclohexane (DMBPC) monomer, for example, as the predominant or sole hydroxy monomer, hereafter referred to as DMBPC polycarbonate. More specifically, the thermoplastic film can comprise a blend of a polycarbonate comprising repeat units from, and made by the polymerization of, dimethyl bisphenol cyclohexane (DMBPC) monomer and a polycarbonate comprising repeat units from, and made by the polymerization of, bisphenol A monomer, for example, as the predominant or sole hydroxy monomer, hereafter referred to as bisphenol A polycarbonate.

In an exemplary embodiment, the film substrate of the coated polycarbonate thermoplastic film is a multilayer film comprising a layer that is a blend of DMBPC polycarbonate in an amount of 0 to 50 weight percent and a bisphenol A polycarbonate in the amount of 50 to 100 weight percent, where weight percents are based on the total weight of the composition in the layer.

In one specific embodiment, the film substrate is a co-extruded multilayer film substrate comprising a first layer (which can be the cap or upper layer with respect to the molded article and the layer having the coating) comprising a blend of DMBPC polycarbonate and bisphenol A polycarbonate and a second adjacent layer comprising bisphenol A polycarbonate without DMBPC polycarbonate. The first layer is, for example, 0 to 50%, specifically 10 to 40%, of the thickness of the multilayer film substrate, and the second layer is 50% to 100%, specifically 60 to 90%, of the thickness of the multilayer film.

In some embodiments, the film substrate can be 25 to 1500 micrometers thick, specifically 100 to 800 micrometers, and the coating can be 1 to 50 micrometers thick, specifically 3 to 30 micrometers.

Alternatively, the film substrate can be a monolithic or single layer of bisphenol A polycarbonate. Other types of polycarbonate compositions or polycarbonate blends can be used in a monolithic or multilayer film, which polycarbonates are described in greater detail below.

The polycarbonate film substrate disclosed herein can be made by a process wherein the coating composition is applied onto a moving web of the film substrate at a wet coating thickness of, for example, 3 to 30 micrometers, wherein the wet coating is nipped between a smooth metal plate used as a casting roll, for example a chrome plated steel roll, and a rubber or elastomeric roll and, while the coated polycarbonate thermoplastic film is in contact with the chrome plated steel roll, is exposed to UV energy to activate polymerization of the coating, wherein the casting roll temperature is about 160 to 200° F. (71.1 to 93.3° C.), more specifically, 170 to 180° F. (76.7 to 82.2° C.).

A molded article is herein disclosed comprising the above-described coated polycarbonate film after the film is printed (decorated) on one surface thereof with a print (decoration) and bonded to an injection molded polymeric base structure. The coated polycarbonate film can be cold formed or thermoformed into a three-dimensional shape matching the three-dimensional shape of the injection molded polymeric base structure.

The polymeric base structure is an injection molded polymer composition or “resin” that can also be made of a polycarbonate or blend of polycarbonate with one or more other polymer. However, polycarbonates are not required for the base polymer composition. Such base polymers can include, for example, a blend of bisphenol A polycarbonate and a cycloaliphatic polyester comprised of cycloaliphatic diacid and cycloaliphatic diol units (polycyclohexane dimethanol cyclohexane dicarboxylate), ABS (an acrylonitrile-butadiene-styrene block copolymer), ABS polymer blends, aromatic polycarbonate/ABS polymer blends, and combinations comprising at least one of the foregoing. Specifically, the base polymeric structure can comprises a blend of an aromatic polycarbonate and a polymer selected from the group consisting of PBT (poly(butylene terephthalate)), PCCD (polycyclohexane dimethanol cyclohexane dicarboxylate), PET (poly(ethylene terephthalate)), ABS (acrylonitrile-butadiene-styrene block copolymer), PMMA (poly(methyl methacrylate)), PETG (polyethylene terephthalate glycol), and mixtures of at least one of the foregoing polymers.

Various thermoplastic resins that can be used in the base polymer structure are available from the Sabic Innovative Plastics Company under the trademarks: Lexan® (an aromatic polycarbonate), Cycolac® (an acrylonitrile-butadiene-styrene polymer), Cycoloy® (an aromatic polycarbonate/ABS polymer composition), Xylex® (an aromatic polycarbonate/amorphous polyester composition), Xenoy® (an aromatic polycarbonate/polybutylene terephthalate polymer composition), Valox® (polybutylene terephthalate) resin, including homopolycarbonates, copolycarbonates, copolyester carbonates, and combinations comprising at least one of the foregoing.

In one embodiment, the injection molded base polymer can be a transparent polycarbonate (PC). Higher flow transparent materials (like LEXAN SP, a super high flow PC grade produced by GE Plastics) can provide an improvement in terms of viscosity, especially for thinner-walled IMD molds where their fast injection speeds.

A specific polycarbonate polymer for use in the base polymer structure consists of an aromatic polycarbonate of more than 99 wt. % of bisphenol-A polycarbonate made from 2,2-bis(4-hydroxy phenyl) propane, (i.e., Bisphenol-A).

Also disclosed herein is a method of molding an article, comprising placing the above-described decorative film into a mold, and injecting a base polymer composition into the mold cavity space behind the decorative film, wherein the decorative film and the injection molded base polymer composition form a single molded part or article.

According to one exemplary embodiment, molded articles are prepared by: printing a decoration on a surface of a coated polycarbonate film substrate, for example by screen printing to form a decorative film; forming and optionally trimming the decorative film (including printed substrate) into a three-dimensional shape; fitting the decorative film into a mold having a surface which matches the three-dimensional shape of the decorative film; and injecting a base polymer composition, which can be substantially transparent, into the mold cavity behind the decorative film to produce a one-piece, permanently bonded three-dimensional article or product.

For instance, for some cell phones or other wireless electronic devices, a film with ink patterns can be back molded with a transparent resin to mold the complete front cover or housing. This can be done so that information can be visually accessed by the product's user through a transparent window which is integrated into the structural resin of the product's design. Data can be transferred to/from the electronic device to its server by IR through the transparent window. Holes in the decorative film can be provided to expose the transparent injected molded base resin for either data transfer or aesthetic purposes. The coated films disclosed herein can also be used for exterior automotive insert mold decoration (IMD) applications, among other uses.

The surface of the polycarbonate film substrate opposite the coating can be subsequently printed or decorated, for example, with markings selected from the group consisting of alphanumerics, graphics, symbols, indicia, logos, aesthetic designs, multicolored regions, and a combination comprising at least one of the foregoing. In some cases, the coated PC film can be used solely as a protective film optionally shaped, without printing. The coated PC film can also be subjected to printing with ink and shaped into a three-dimensional film for specific applications. Optional shaping can include, for example, non-planar shapes or a complex geometry in cross-section of the initial sheet. A planar sheet can be shaped into an irregular shape comprising a plurality of bends or inflections. A shaped sheet can comprise a plurality of protuberances or indentations that define a space or volume diverging from the original plane of coated thermoplastic film.

If the final piece is three dimensional, there are various techniques for forming three-dimensional IMD parts. For example, for parts having a draw depth greater than or equal to 1 inch (2.54 cm), thermoforming or variations of thermoforming can be employed. Variations include but are not limited to vacuum thermoforming, zero gravity thermoforming, plug assist thermoforming, snap back thermoforming, pressure assist thermoforming, and high pressure thermoforming. For parts containing detailed alphanumeric graphics or draw depths less than 1 inch (2.54 cm), cold forming techniques are exemplary. These include but are not limited to embossing, matched metal forming, bladder or hydro forming, pressure forming, or contact heat pressure forming.

For IMD processes, high temperature, formable inks can be used for graphics application. Second surface decoration can employ more robust ink systems to provide adequate ink adhesion during the molding process. Moreover, in applications such as light assemblies where light transmission is important, dye inks can be used rather than pigmented inks so as not to affect light transmission and haze readings. Possible inks include the following: Naz-dar 9600 and 8400; Coates C-37 Series and Decomold Ultrabond DMU; Marabuwerke IMD Spezialfarbe 3061, IMD 5001 with tie layer, and MPC; Nor-cote (UK) IMD and MSK Series' with tie layer; Sericol Techmark MTS with tie layer and Techmark IMD; Proell N2K, M1, M2, and Noriphan HTR; Seiko Advance KKS Super Slow Dry; Seiko Advance AKE(N) w/N3A, JT10, or JT20 binder; Teikoku IPX series w/IMB003 binder; Jujo 3300 series; Jujo 3200 series with G2S binder.

Prototype molds can be constructed from common materials such as plaster, hard woods, fiberglass, syntactic foam and silicone. These materials are relatively easy to work with and allow minor modifications. It is common practice for designers to experiment with IMD to cast a silicone forming mold off an existing injection mold. For example, production forming tools should be constructed of durable materials such as cast or machined aluminum, steel or metal filled epoxy. Conductive molds should be internally heated to a temperature of 250° F. (121° C.).

The injection molded article or part can contract in size once it is removed from the mold and allowed to cool. The amount of shrinkage depends on the material selected, but it is predictable and can be accounted for when calculating the mold dimensions. The same is true for the expansion of the mold at operating temperatures. For example, LEXAN® polycarbonate film can typically shrink approximately 0.5 to 0.9% after forming, depending on the mold. The thermal expansion properties of the mold material at an operating temperature of 250° F. (121° C.) can be subtracted from the film shrinkage number to obtain accurate mold dimensions. In addition, draft angles of 5 to 7 degrees can be suggested to facilitate part removal from male molds. Female molds require less draft (1 to 2 degrees).

Considerations in gating include part design, flow, end use requirements, and location of in-mold graphics. The standard guidelines of traditional gating can apply to IMD along with several extra considerations. For example, one gate can be used whenever possible to minimize the potential for wrinkling the film. Gates can be located away from end-use impact as well as to provide flow from thick to thin sections to minimize weld lines. Gates can also be located at right angles to the runner to minimize jetting, splay and gate blush. Large parts requiring multiple gates can include gate positions close enough together to reduce pressure loss. Sequential gating can be used to prevent folding of the film at weld lines. Gate land lengths can be kept as short as possible. An impinging gate can be used to ensure that the incoming flow is directed against the cavity wall or core to prevent jetting. Venting (particularly full perimeter venting) can be accomplished by knock outs, cores, and parting lines and can be used whenever possible to avoid trapped gas that can burn and rupture the film. In addition, flow restrictions near gate areas can increase the potential for wash out due to increased shear. If bosses, core shutoffs, etc., are needed near a gate, rounded features or corners can be used to reduce shear. Finally, care can also be taken to ensure that the gating distributes the injection pressure over a large area, thus reducing the shear forces at the gate. Examples of gates that can accomplish this include fan gates and submarine gates that enter the part via a rib. It is common to add a puddle or thicker area at the gate entrance point for gates like valve gates, hot drops, cashew gates in order to create a pressure drop and reduce potential for washing the ink away at the gate.

When selecting a base polymer composition (also referred to as “resin”), it is advantageous that the resin's viscosity be sufficiently low such that the pressure necessary to inject it into the mold can be reduced. In addition, the injection can be profiled so that the viscosity of the injected material maintained at a sufficiently low level in the gate area and can be raised after a suitable skin layer is established near the gate. At lower viscosity, the shear force of the injected material is lower and is therefore less likely to disturb the ink on the second surface of the substrate.

The decorations or graphics can be printed on the film substrate so that they extend beyond the gating area and into the runner system. In this case, if the ink is disturbed by the flow of the injected material, it can be disturbed in the runner area that can be trimmed off after the part is ejected from the mold. Runnerless systems or heated gating systems can also be employed. With a runnerless system, the drop diameter can be large enough to sufficiently distribute the pressure or flow into a part, such as a rib. With a heated gating system, the tips of the heated gates can be maintained at a temperature sufficiently below the softening temperature of the film substrate so as to prevent film substrate deformation.

Screen-printing is an example of a technique for producing graphics on coated film substrates of the present invention. Screen-printing is essentially a stencil printing process, which can now be generated by computer with the aid of various software packages. Its ability to vary and control ink thickness accurately has made it an extremely useful process for the decoration of many different types of plastic substrates.

In screen printing, a screen or stencil is prepared and bonded to a fine weave fabric, which is then tensioned in a rigid frame. Frames can be made of either wood or metal, with metal being preferred. The frame can be dimensionally stable and able to withstand handling during the printing process. Screen fabrics are generally made from metallized polyester, nylon, stainless steel, and most commonly, polyester. The fabric can be tightly woven under precise control using dimensionally exact filaments. There are a number of variables that can affect ink deposit, including thread diameter, squeegee angle and hardness, emulsion thickness, etc. Higher mesh screens are suggested for formed IMD applications.

A typical screen printing process involves the use of a flat bed where the film substrate is held by vacuum during printing. A frame holder positions the screen and holds it both vertically and horizontally during the printing process. With the screen lowered over the substrate bed and held at the off contact distance by the press, the squeegee carrier moves the blade across the screen at a preset speed, pressure, stroke and angle.

It is important to register artwork during a screen printing operation. This is normally done by locking the frame into a holder that aligns the frame using pins or holders. The pin alignment method is often used because the artwork can be aligned along with the screen frame. Alignment of the substrate with the print image can be done through the use of edge guides, mechanical stops or automatic devices. The first color can be aligned by this method and subsequent colors aligned through the use of targets or gauge marks which are printed alongside the artwork.

Once the ink is printed, it can be either dried or cured depending on the ink technology used. If the ink is solvent or water based, then a gas fired or electric dryer can be used to dry the ink. When printing on plastic films, the temperature and dwell time in the oven can be controlled to avoid distorting the film. If a solvent ink is used, an oven with good air flow can be used to dissipate the fumes. It is also possible to use an infrared dryer on some ink types, in which temperature control of the system can be applied. If the ink is UV curable, many commercial systems and units are available for curing such reactive ink types.

Printing or decorating on the coated PC film can be performed on the underside of the polycarbonate film substrate but can also or alternatively be on the upper side of the polycarbonate film substrate, i.e. the surface which becomes the interface between the polycarbonate film substrate and hard coat. Generally, the hard coat is not printable but can be decorated by other means.

Among desirable performance properties of a transparent decorative film and articles in which it is contained is that it can (a) pass a scribe adhesion test, (b) have a maximum percent haze, (c) be formed, and/or (d) have a birefringence of less than or equal to 20 nm. A low birefringence overlay film can be used for three-dimensional thermoformed (vacuum or pressure forming) articles prepared by IMD process for applications that require tight graphics registration. Various advantageous properties of the present coated film are described below in greater detail in the examples.

The coated polycarbonate substrate disclosed herein can be an extruded sheet or film that can be produced by a method comprising feeding a polycarbonate composition or resin into an extruder which heats the resin above its glass transition temperature (Tg), thereby producing a viscous melt of the thermoplastic material. The term “film” or “sheet” is used interchangeably herein. Such extrude films can have a final thickness of about 1 to about 30 mils (25 to 762 micrometers). In an embodiment, a viscous melt of the composition can be passed, under pressure provided by the extruder, through an opening in a die, which opening typically has the shape of an elongated rectangle or slot. The viscous melt assumes the shape of the die slot, thereby forming a continuous sheet or film of molten extrudate. The die center zone temperatures can be, for example, in the range of 550 to 650° F. (288 to 343° C.). The die edge zone temperatures can be higher to compensate for the film edge cooling at a faster rate than the film center. The film of molten extrudate can then be passed through finishing apparatus to form the sheet or film and used as a film substrate to be coated.

A finishing apparatus, for example, can comprise (as described, for example, in U.S. Pat. No. 6,682,805) a two-roll finishing or polishing stack comprising an opposing upper roll and lower roll spaced apart by a distance that generally corresponds to the desired thickness of the finished thermoplastic sheet or film. Such rolls are also sometimes referred to as calendaring rolls with a gap or nip there between. A typical finishing stack comprises opposing upper and lower steel roller. The upper roll can be covered with an elastomeric material, such as rubber, and the lower roll can have a chrome plated smooth surface. These rolls can be cooled internally by passing a fluid through the interior of the rolls using known apparatus and methods for cooling, by which the temperature of the surface of the rolls can be controlled by this method. The film can be passed through an additional nip in some cases. The film can also pass through a thickness scanner, through pull rolls, and wound onto a winder.

The temperature of the rolls can be controlled to a temperature that is below Tg of the thermoplastic material that is being processed. In the gap between the rolls, the surfaces of the sheet or film can be abruptly vitrified via contact with the calendaring rolls. Therefore, upon contact with the rolls, the interior portion of the film can remain in the thermoplastic or molten state.

As used herein, with respect to embodiments of the coated extruded polycarbonate film substrate and/or the injection molded base polymer (which optionally comprises a polycarbonate resin), the term “polycarbonate” means compositions having repeating structural carbonate units of formula (1):

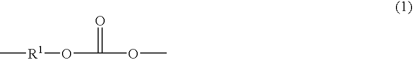

in which at least about 60 percent of the total number of R¹ groups contain aromatic moieties and the balance thereof are aliphatic, alicyclic, or aromatic. In an embodiment, each R¹ is a C₆₋₃₀ aromatic group, that is, contains at least one aromatic moiety. R¹ can be derived from a dihydroxy compound of the formula HO—R¹—OH, in particular of formula (2):

HO-A¹-Y¹-A²-OH (2)

wherein each of A¹ and A² is a monocyclic divalent aromatic group and Y¹ is a single bond or a bridging group having one or more atoms that separate A¹ from A². In an exemplary embodiment, one atom separates A¹ from A². Specifically, each R¹ can be derived from a dihydroxy aromatic compound of formula (3)

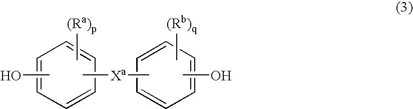

wherein R^{a} and R^{b} each represent a halogen or C₁₋₁₂ alkyl group and can be the same or different; and p and q are each independently integers of 0 to 4. It will be understood that R^{a} is hydrogen when p is 0, and likewise R^{b} is hydrogen when q is 0. Also in formula (3), X^{a} represents a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group X^{a} is single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In one embodiment, p and q is each 1, and R^{a} and R^{b} are each a C₁₋₃ allyl group, specifically methyl, disposed meta to the hydroxy group on each arylene group.

In one embodiment, X^{a} is a substituted or unsubstituted C₃₋₁₈ cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Exemplary groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene.

A specific example wherein X^{a} is a substituted cycloalkylidene is the cyclohexylidene-bridged, alkyl-substituted bisphenol of formula (4)

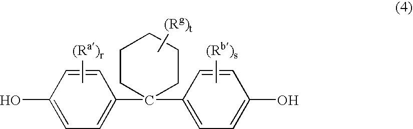

wherein R^{a}′ and R^{b}′ are each independently C₁₋₁₂ alkyl, R^{g} is C₁₋₁₂ alkyl or halogen, r and s are each independently 1 to 4, and t is 0 to 10. In a specific embodiment, at least one of each of R^{a}′ and R^{b}′ are disposed meta to the cyclohexylidene bridging group. The substituents R^{a}′, R^{b}′, and R^{g} can, when comprising an appropriate number of carbon atoms, be straight chain, cyclic, bicyclic, branched, saturated, or unsaturated. In an embodiment, R^{a}′ and R^{b}′ are each independently C₁₋₄ alkyl, R^{g} is C₁₋₄ alkyl, r and s are each 1, and t is 0 to 5. In another specific embodiment, R^{a}′, R^{b}′ and R^{g} are each methyl, r and s are each 1, and t is 0 or 3. The cyclohexylidene-bridged bisphenol can be the reaction product of two moles of o-cresol with one mole of cyclohexanone. In another exemplary embodiment, the cyclohexylidene-bridged bisphenol is the reaction product of two moles of a cresol with one mole of a hydrogenated isophorone (e.g., 1,1,3-trimethyl-3-cyclohexane-5-one). Such cyclohexane-containing bisphenols, for example the reaction product of two moles of a phenol with one mole of a hydrogenated isophorone, are useful for making polycarbonate polymers with high glass transition temperatures and high heat distortion temperatures.

In another embodiment, X^{a} is a C₁₋₁₈ alkylene group, a C₃₋₁₈ cycloalkylene group, a fused C₆₋₁₈ cycloalkylene group, or a group of the formula —B¹—W—B²— wherein B¹ and B² are the same or different C₁₋₆ alkylene group and W is a C₃₋₁₂ cycloalkylidene group or a C₆₋₁₆ arylene group.

Specific examples of bisphenol compounds of formula (3) include 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (PPPBP), and 1,1-bis(4-hydroxy-3-methylphenyl)cyclohexane (DMBPC). Combinations comprising at least one of the foregoing dihydroxy compounds can also be used. In one specific embodiment, the polycarbonate is a linear homopolymer derived from bisphenol A, in which each of A¹ and A² is p-phenylene and Y¹ is isopropylidene in formula (3).

The polycarbonates can have an intrinsic viscosity, as determined in chloroform at 25° C., of about 0.3 to about 1.5 deciliters per gram (dl/gm), specifically about 0.45 to about 1.0 dl/gm. The polycarbonates can have a weight average molecular weight of about 10,000 to about 200,000 Daltons, specifically about 20,000 to about 100,000 Daltons, as measured by gel permeation chromatography (GPC), using a crosslinked styrene-divinylbenzene column and calibrated to polycarbonate references. GPC samples are prepared at a concentration of about 1 mg per ml, and are eluted at a flow rate of about 1.5 ml per minute.

“Polycarbonates” as used herein further include homopolycarbonates, (wherein each R¹ in the polymer is the same), copolymers comprising different R¹ moieties in the carbonate (referred to herein as “copolycarbonates”), copolymers comprising carbonate units and other types of polymer units, such as ester units, and combinations comprising at least one of homopolycarbonates and/or copolycarbonates. As used herein, a “combination” is inclusive of blends, mixtures, alloys, reaction products, and the like.

In one embodiment, J is a C₂₋₃₀ alkylene group having a straight chain, branched chain, or cyclic (including polycyclic) structure. In another embodiment, J is derived from an aromatic dihydroxy compound of formula (3) above. In another embodiment, J is derived from an aromatic dihydroxy compound of formula (4) above. In another embodiment, J is derived from an aromatic dihydroxy compound of formula (6) above.

Polycarbonates can be manufactured by processes such as interfacial polymerization and melt polymerization. Although the reaction conditions for interfacial polymerization can vary, an exemplary process generally involves dissolving or dispersing a dihydric phenol reactant in aqueous caustic soda or potash, adding the resulting mixture to a water-immiscible solvent medium, and contacting the reactants with a carbonate precursor, such as carbonyl chloride, in the presence of a catalyst such as triethylamine and/or a phase transfer catalyst, under controlled pH conditions, e.g., about 8 to about 12. The most commonly used water immiscible solvents include methylene chloride, 1,2-dichloroethane, chlorobenzene, toluene, and the like.

Branched polycarbonate blocks can also be used, and they can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane (THPE), isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of about 0.05 to about 2.0 wt %. Mixtures comprising linear polycarbonates and branched polycarbonates can be used.

A chain stopper (also referred to as a capping agent) can be included during polymerization. The chain stopper limits molecular weight growth rate, and so controls molecular weight in the polycarbonate. Exemplary chain stoppers include certain mono-phenolic compounds, mono-carboxylic acid chlorides, and/or mono-chloroformates.

The injection molded base polymers can further include impact modifier(s) that do not adversely affect the desired composition properties, including light transmission. Impact modifiers can include, for example, high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used.

Impact modifiers, when used, can be present in amounts of 1 to 30 wt. %, based on the total weight of the polymers in the composition.

The thermoplastic composition for the polymeric film substrate or injection molded base polymer can include various additives (e.g., filler(s) and/or reinforcing agent(s)) ordinarily incorporated in resin compositions of this type, with the proviso that the additives are selected so as to not significantly adversely affect the desired properties of the extrudable composition, for example, light transmission of greater than 50%. Combinations of additives can be used. Such additives can be mixed at a suitable time during the mixing of the components for forming the composition.

Other optional additives for thermoplastic compositions, either extruded films or injection molded resins, include antioxidants, flow aids, mold release compounds, UV absorbers, stabilizers such as light stabilizers and others, flame retardants, lubricants, plasticizers, colorants, including pigments and dyes, anti-static agents, metal deactivators, and combinations comprising one or more of the foregoing additives. Such additives are selected so as to not significantly adversely affect the desired properties of the composition.

The coated polycarbonate films and decorative films disclosed herein have numerous applications, for example, cell phone covers (top, bottom, flip); cell phone lenses; cell phone key pads; lap and computer covers; key boards; membrane switches; adhesive labels; buttons and dials of interior automotive interfaces; heat ventilation & air conditioning panels; automotive clusters; control panels for appliances (washer, dryer, microwave, air conditioner, refrigerator, stove, dishwasher, etc.); housings, lenses, keypads, or covers for hand held devices (blood analyzers, calculators, MP3 or MP4 players, gaming devices, radios, satellite radios, GPS units, etc.); touch panel displays; screens, keypads, membrane switches, or other user interfaces for ATMs, voting machines, industrial equipment, and the like; housings, lenses, keypads, membrane switches, or covers for other consumer and industrial electronic devices (TVs, monitors, cameras, video camcorders, microphones, radios, receivers, DVD players, VCRs, routers, cable boxes, gaming devices, slot machines, pachinko machines, cash registers, hand held or stationary scanners, fax machines, copiers, printers, etc); covers and buttons of memory storage devices and flash drives; covers and buttons for the mouse, blue tooth transmitters, hands free devices, headsets, earphones, speakers, etc; labels, housings, lenses, touch interfaces for musical instruments such as electronic key boards or periphery equipment such as amplifiers, mixers, and sound boards; and displays, covers, or lenses of gauges, watches, and clocks.

### EXAMPLES

### Coating Composition

Oligomer selection was made to provide a range of flexibility, adhesion the substrate, scratch and abrasion resistance. Difunctional monomer 1,6-hexanediol diacrylate ( HDODA) diluent was used to reduce coating viscosity and to enhance adhesion properties. The coatings were formulated as 100% solids (no water or solvent present) and applied with heating (to reduce viscosity further on application to 50 to 200 cps). Temperatures of 120 to 150° F. (48.9 to 65.6° C.) were found to produce acceptable viscosities for application. Functionality levels of the various monomers were varied from low to high to determine the affect on Taber haze and flexibility of the cured film product. The monomer and oligomers used in the following examples of coating compositions are listed in Table 1 along with corresponding values of functionality, tensile strength, elongation, temperature of glass transition (Tg) and supplier. The tensile strength at break and elongation was based on ASTM D882, the standard test method for tensile properties of thin plastic films.

TABLE 1

| | | | Tensile | | | |
|---|---|---|---|---|---|---|
| Component | | | Strength, | | Tg, | Supplier |
| No. | Urethane Acrylate | Functionality | psi | Elongation, % | ° C. | name |
| Monomer | HDODA | 2 | Not | Not | 43 | Cytec |
| | | | applicable | applicable | | |
| Oligomer 1 | EBECRYL 1290 | 6 | 6700 | 2 | 69 | Cytec |
| Oligomer 2 | EBECRYL 8301 | 6 | 7750 | 3 | 63 | Cytec |
| Oligomer 3 | PHOTOMER 6892 | 3 | 1300 | 47 | 14 | Cognis |
| Oligomer 4 | PHOTOMER 6010 | 2 | 2060 | 45 | −10 | Cognis |
| Oligomer 5 | CN9010 | 6 | 6500 | 3 | 108 | Sartomer |
| Oligomer 6 | CN9013 | 9 | 12630 | 2 | 143 | Sartomer |
| Oligomer 7 | CN9290 | 2 | 450 | 125 | −28 | Sartomer |
| Oligomer 8 | PHOTOMER 6184 | 3 | 5380 | 7 | 53 | Cognis |
| Oligomer 9 | EBECRYL 8405 | 4 | 4000 | 29 | 30 | Cytec |
| Oligomer | EBECRYL 284 | 2 | 5900 | 58 | 50 | Cytec |
| 10 | | | | | | |

Photoinitiator is added to the coating blends in order to facilitate curing of the coating under UV exposure. The following photoinitiators were investigated and listed as follows in Table 2 below.

TABLE 2

| No. | Trademark | Description | Source |
|---|---|---|---|
| Photoinitiator 1 | Darocur | 2-hydroxy-2-methyl-1- | Ciba-Geigy |
| | 1173 | phenyl-1-propanone | |
| Photoinitiator 2 | Irgacure | Bis(2,4,6-trimethylbenzoyl) | Ciba-Geigy |
| | 819 | phenylphosphine oxide | |

Examples of coating compositions (components are given in weight %) are listed in Table 2. Coating examples that resulted in loss of adhesion (rating 0 B) after 72-hour exposure to 85° C. and 95% relative humidity indicated as comparative.

TABLE 2

| | | | | | | | | | | | Olig. | Ph. | Ph. |
|---|---|---|---|---|---|---|---|---|---|---|---|---|---|
| Coating No. | HDOD A | Olig. 1 | Olig. 2 | Olig. 3 | Olig. 4 | Olig. 5 | Olig. 6 | Olig. 7 | Olig. 8 | Olig. 9 | 10 | In. 1 | In. 2 |
| Coating 1 | 39.5 | 59.5 | | | | | | | | | | 1 | |
| Coating 2 | 39.5 | | 59.5 | | | | | | | | | 1 | |
| Coating 3 | 39.5 | | | 59.5 | | | | | | | | 1 | |
| Comparative | 39.5 | | | | 59.5 | | | | | | | 1 | |
| Coating 4 | | | | | | | | | | | | | |
| Coating 5 | 39.5 | 59.5 | | | | | | | | | | | 1 |
| Coating 6 | 39.5 | | 59.5 | | | | | | | | | | 1 |
| Coating 7 | 39.5 | | | 59.5 | | | | | | | | | 1 |
| Comparative | 39.5 | | | | 59.5 | | | | | | | | 1 |
| Coating 8 | | | | | | | | | | | | | |
| Coating 9 | 39.5 | | | | | 59.5 | | | | | | 1 | |
| Comparative | 39.5 | | | | | | 59.5 | | | | | 1 | |
| Coating 10 | | | | | | | | | | | | | |
| Comparative | 39.5 | | | | | | | 59.5 | | | | 1 | |
| Coating 11 | | | | | | | | | | | | | |
| Comparative | 39.5 | | | | | | | | 59.5 | | | | 1 |
| Coating 12 | | | | | | | | | | | | | |
| Coating 13 | 39.5 | | | | | | | | | 59.5 | | | 1 |
| Comparative | 39.5 | | | | | | | | | | 59.5 | | 1 |
| Coating 14 | | | | | | | | | | | | | |

The amount of monomer was kept constant at 39.5% to ensure appropriate comparison of different aliphatic urethane acrylates. The application temperature of coatings was varied slightly to achieve similar application viscosity (about 100 cps) and coating thickness (approximately 10-15 micron) for the cured films. The application of coating was achieved using a hand feed laminator by Innovative Machine Corporation (Birmingham, Ala.). Bisphenol A polycarbonate film was used as a substrate for coating examples 1 to 14. The film had a thickness of 10 mil (250 micron). The coating was cured through the film to avoid presence of oxygen (air). Fusion F300S-12® Ultraviolet Curing System (Fusion UV Systems, Inc) using either Fusion “H” or “V” bulb was used to cure the coatings. The H-bulb was used for coatings containing Darocur 1173® (Photoinitiator 1) and the-V bulb was used for coatings containing Irgacure 819® (Photoinitiator 2). The conveyor speed (MC-12 conveyor by R&D Equipment, Norwalk, Ohio) was kept constant at 20 feet per minute to achieve the same UV-dose of approximately 0.7 J/cm².

The results of physical testing for each coating composition are listed in Table 3. Coating examples that resulted in loss of adhesion (rating 0 B) after 72-hour exposure to 85° C. and 95% relative humidity are indicated as comparative.

TABLE 3

| | | | | | Adhesion |
|---|---|---|---|---|---|
| | | | | | Test after |
| | | Abrasion | | | 72 hrs at |
| | Adhesion | Test Delta | Mandrel Bend | | 85° C. & |
| Coating No. | Test | Haze, % | Test, inches (mm) | | 95% RH |
| Coating 1 | 5B | 7.5 | 0.375″ | (9.5 mm) | 5B |
| Coating 2 | 5B | 6.8 | 0.4375″ | (11.2 mm) | 5B |
| Coating 3 | 5B | 2.9 | 0.125″ | (3.2 mm) | 5B |
| Comparative | 5B | 5.8 | 0.125″ | (3.2 mm) | 0B |
| Coating 4 | | | | | |
| Coating 5 | 5B | 5.2 | 0.5″ | (12.7 mm) | 5B |
| Coating 6 | 5B | 6.4 | 1″ | (25.4 mm) | 5B |
| Coating 7 | 5B | 4.4 | 0.125″ | (3.2 mm) | 5B |
| Comparative | 5B | 6.1 | 0.125″ | (3.2 mm) | 0B |
| Coating 8 | | | | | |
| Coating 9 | 4B | 7.8 | 1″ | (25.4 mm) | 5B |
| Comparative | 4B | 6.7 | 1″ | (25.4 mm) | 0B |
| Coating 10 | | | | | |
| Comparative | 5B | 5.8 | 0.125″ | (3.2 mm) | 0B |
| Coating 11 | | | | | |
| Comparative | 5B | 9.4 | 0.125″ | (3.2 mm) | 0B |
| Coating 12 | | | | | |
| Coating 13 | 5B | 2.2 | 0.125″ | (3.2 mm) | 5B |
| Comparative | 5B | 5.8 | 0.125″ | (3.2 mm) | 0B |
| Coating 14 | | | | | |

Coating compositions 3 and 7 containing oligomer 3 (Photomer 6892®) and composition 13 containing oligomer 9 (Ebecryl 8405®), base on the results in Table 3 are particularly superior in terms of flexibility (passed minimum mandrel of 0.125″ or 3.2 mm without cracking), Taber abrasion (delta haze was less than 5%) and no adhesion failures after environmental testing (5B adhesion after 72 hrs at 85° C. & 95% RH).

Coatings 3, 7 and 13 illustrate that the functionality (3 to 4), tensile strength (1300 psi to 4000 psi), elongation (29% to 47%) and temperature of glass transition (14° C. to 30° C.) for the aliphatic urethane acrylate resulted in a desired performance. Examples 3, 7 and 13 showed improvements in Taber haze values compared to the higher functional oligomers. The Tabor abrasion is measured under ASTM D1044-08method using CS10F wheel with 500 grams weight and measuring the haze in the samples before and after 100 of abrasion cycles, and listing the initial haze and the change in haze (delta haze %). The flexibility of the cured films as observed in mandrel bend testing (based on ASTM D3363-05) was also improved with reduced functionality as illustrated with the ability of the coated film to pass the ⅛ inches (3.18 mm) mandrel bend. A coating composition containing oligomer 9 showed some cracking during thermoforming or embossing, suggesting that the properties of oligomer 3 are more superior without further changes to the specific composition or specific process of use Adhesion test follows ASTM D3002-07 standard methodology. The rating for this test for coating adhesion is visual, starting with 5B for the best adhesion down to 0 B for the lowest rating for adhesion.

### Film Substrate Preparation

The film substrate used is LEXAN® polycarbonate film from Sabic Innovative Plastics that is made via polymerization of dimethyl bisphenol cyclohexane (DMBPC) monomer. DMBPC polymer generates resins of superior hardness compared to traditional bisphenol A (BPA) polycarbonate, and DMBPC was used in the film substrate for the overall coated film with the coating formula of Coating 7 from Table 4 to generate a film with superior pencil hardness (ASTM D3363) compared to using the same coating on a bisphenol A polycarbonate film substrate. The DMBPC monomer is of the following structure:

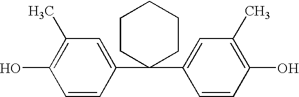

DMBPC polymer alone, however, can be brittle and not easily trimmed without cracking. To meet these challenges, DMBPC is blended with BPA polycarbonate and then co-extruded with DMBPC polycarbonate to create a DMBPC and polycarbonate layer construction. The preferred composition is 50/50 DMPC commercial grade DMX2415 and BPA polycarbonate commercial grade ML9735 from Sabic Innovative Plastics that is extruded to form film construction of 30% DMBPC polycarbonate and 70% BPA polycarbonate.

The DMBPC blend and polycarbonate multilayer film is made via a continuous calendaring co-extrusion process. Co-extrusion consist of a melt delivery system via a set of extruders each supplying the molten resin for individual layers. These melt streams are then fed into a feed block and then a die which form a molten polymeric web that feed a set of calendaring rolls. A calendar typically consists of 2 to 4 counter rotating cylindrical rolls. These rolls are typically made from steel or rubber-covered steel, which are internally heated or cooled. The molten web formed by the die is successively squeezed between these rolls. The inter-roll clearances or “nips” through which the polymers are drawn through determine the thicknesses of the films.

Co-extruded film articles consisting of a cap layer containing various amounts of DMBPC and bisphenol A polycarbonate substrate were made via a continuous calendaring co-extrusion process. Commercial grade LEXAN® ML9735 polycarbonate from Sabic Innovative Plastics was used for the second layer of the film substrate. The gauge is approximately 10 mil (254 μm) and the percentage of the cap layer containing DMBPC is approximately 30% of the overall thiclness of the film. Monolithic polycarbonate extruded film was also made via continuous calendaring co-extrusion process using commercial grade LEXAN® ML9735 polycarbonate.

### Coating Process

Coating of the mentioned substrate were conducted on a production scale coating line. A thin film of coating was applied onto the moving web using a gravure coating process. A gravure roll with engraved cell volume of 19.19 BCM (Pamarco tool ref# 49-110 THC) was used to achieve target wet coating thickness of 15 to 20 micrometers. The wet coating was then nipped between a chrome plated steel roll (Ra between 0 and 1 micro-inches or 0 and 25.4 nanometers (nm)) and a rubber roll to eliminate air bubbles and impart a polish texture to the coated film. As the coated film is in contact with the chrome roll, it is exposed to UV energy of a specific spectral distribution and intensity to activate free radicals and initiate the polymerization of the coating. In this case, 2 (two) ‘V’ type bulbs arranged lengthwise rated at 600 watts per inch (W/in; 92.8 watts per centimeter (W/cm)) each manufactured by Fusion UV systems was used. The cured coating was then stripped off the casting roll while maintaining good adhesion to the substrate. The radiation curable coating was 100% solids and free of any volatile species such as solvents.

Interfacial adhesion between the coating and PC film substrate relies on the ability of the coating to wet the PC surface. In addition the coating needs to solvate the interface enough to develop a strong interfacial bond. The strength of this bond is typically validated by tests such as ASTM D3359-02 which on a scale of 0-5 B indicate the strength of the bond. A rating of 0 B would indicate no adhesion and 5 B would indicate strong adhesion to the interface.

Table 5 below identifies process parameters which control the level of interfacial adhesion.

TABLE 5

| | Coating | Casting roll | Lamp | | Adhesion |
|---|---|---|---|---|---|
| | temperature | temperature | power | Adhesion | (72 hours |
| Run | (° F./° C.) | (° F./° C.) | (%) | (t = 0, RT) | 80/95% RH) |
| 1 | 137/58.3 | 150/65.6 | 50 | 5B | 0B |
| 2 | 137/58.3 | 150/65.6 | 100 | 5B | 2B |
| 3 | 137/58.3 | 175/79.4 | 50 | 5B | 5B |
| 4 | 137/58.3 | 175/79.4 | 100 | 5B | 5B |
| 5 | 160/71.1 | 160/71.1 | 75 | 5B | 4B |

RH = relative humidity;
RT = room temperature (e.g., about 27° C.); and
t = 0 is at the start (time of zero).

Process factors studied were coating application temperature, casting roll temperature, and UV lamp power. Based on the results from these trials as summarized in Table 5 above, strong adhesion was achieved when casting roll temperature was above 160° F. (71.1° C.). Accordingly, one exemplary embodiment uses a casting roll temperature of 71.1 to 93.0° C. (160 to 200° F.).

U.S. Pat. No. 5,271,968 covers adhesion improvement of radiation curable coating with thermoplastics substrate through contact between the coating and substrate for a specified time and at a temperature of uncured coating and substrate between 90 and 150° F. (32.2 and 65.6° C.) to drive the penetration of the coating into a region below the substrate surface and exposing it to UV energy to cross link and cure the coating. For the current coating formulation comprising of a polyurethane acrylate oligomer, reactive monomer diluent, and photoinitiator, the temperature range of 160 to 175° F. (71.1 to 79.4° C.) achieved desired adhesion of the coating to the thermoplastic film substrate.

### Results

Comparisons are made between new coated film with the Coating 7 and commercial product offering by Sabic Innovative Plastics, namely LEXAN® HP92S coated polycarbonate. The coated film based on Coating 7 can achieve desired performance while maintaining flexibility to be thermoformed. Thus, the present invention can provide a hard coated film that is both thermoformable and able to provide required properties of chemical resistance, scratch, and abrasion resistance without post curing at the same time.

### Scratch Resistance—Pencil Hardness

Pencil hardness was measured using ASTM D3363 method with 500 grams (g) load, which showed that the coated PC film according to the invention is equivalent to HP92S coated film. Coated DMBPC/PC according to the invention is of higher hardness. The results are shown in Table 6 below.

TABLE 6

| | | Pencil Hardness @ |
|---|---|---|
| No. | Samples | 500 g |
| Comparative | LEXAN ® HP92S | HB-F |
| Example 1 | coated PC film | |
| Example 1 | PC film with Coating 7 | HB |
| Example 2 | (DMBPC/PC film with | 1H |
| | Coating & | |

### Ability to be Embossed

Coated sample film samples were embossed at room temp 72° F. under two common shapes for embossed buttons in an application such as electronic keypads and appliances control buttons. The first shape is described as a square/pillow, and it is a shape of square with rounded corners that pillows up in the center. The second shape is described as a dome/rail where the embossed impression showed a rail around the keypad button impression. A total of 12 embossed impressions are made in one embossed set, the embossed impression are varied by the embossed depth ranging from 0.015 inch (0.381 mm), 0.02 inch (0.508 mm), 0.025 inch (0.762 mm), 0.03 inch (0.635 mm). For each of the embossed depths the bevel angles are varied from 20, 25 and 35 degrees. The results are shown in Table 7 below.

TABLE 7

| | | Embossing Depths: |
|---|---|---|
| | | Square/Pillow and |
| No. | Description | Dome/Rail |
| Comparative | LEXAN ® HP92S coated | Cracked at 0.015 inches |
| Example 1 | PC film | (0.381 mm) |
| Example 1 | PC film with Coating 7 | Does not crack/No Cracks |
| | | observed at 0.03 inches |
| | | (0.635 mm) |
| Example 2 | DMBPC/PC film with | No Cracks at 0.025 inches |
| | Coating 7 | (0.635 mm)/Cracked at |
| | | 0.03 inches (0.762 mm) |

No variation in observation between different bevel angles are observed and similar performance are shown for both Square/Pillow and Dome/Rail. The coating film having Coating 7 performed better than LEXAN® HP92S PC coated film.

### Ability to be Thermoformed

All film samples are thermoformed on two separate tools. The first tool is a cell phone tool that has gentle curves with maximum depth of approx 0.5 inches. The coated surface is the outside surface in tension. The second tool is referred to as torture tool with a series of sharp corners and no radius blocks where the heated film are thermoformed on three separate blocks with depths of 0.118 inches (3.00 mm), 0.238 inches (6.04 mm) and 0.352 inches (8.94 mm). All tool temperatures are set at 250° F. (123° C.), and the coated sample films are heated to 325 F-350° F. (163-177° C.) for the thermoforming process. The thermoformed parts are then examined for cracks.

For the cell phone tool, the results are reported as pass and fail wherein cracks in the coatings is a failure. The results from the torture toll are quantified as the amount of stretch and reduction of the film thickness before a certain percentage showed cracks. The results are shown in Table 8 below. The film with Coating 7 thermoformed vastly better than the HP92S coated PC film.

TABLE 8

| | | | Torture tool |
|---|---|---|---|
| | | | (thinning before |
| No. | Description | Cell Phone Tool | cracked) |
| Comparative | LEXAN ® HP92S | Cracked | Not Tested |
| Example 1 | coated PC film | | |
| Example 1 | PC film with | Does not crack | 15% of samples |
| | Coating 7 | | cracked after 23% |
| | | | of thinning |
| Example 2 | DMBPC/PC film | Does not crack | 14% of samples |
| | with Coating 7 | | cracked after 21% |
| | | | of thinning |

### Abrasion Resistance

Abrasion resistance is measured with two tests, a Taber abrasion test per ASTM D1044 and a real world test where the samples are abraded with green Scotch Brite® scour pad. Both techniques measure the sample for haze before the test and then after the application of the abrasive. In the Taber test, a standardize abrasion wheel CS10F is weighted down by a fix weight of 500 gram and the wheel is run over the samples in circles wherein the number of cycles is fixed at 100 cycles. In the scour pad test, the sample is rubbed with the Scotch Brite® scour pad 10 times. The haze of the samples after the application of the abrasive application is recorded and the difference between that and the initial haze are reported. From the data in Table 9 below, it is shown that the new coating showed excellent abrasion resistance behavior.

TABLE 9

| | | | Scotch Brite |
|---|---|---|---|
| | | Tabor 500 g/100cycles | 10 Rubs |
| No. | Description | (Delta Haze) | (Delta Haze) |
| Comparative | LEXAN ® | 6.5 (4.1 post cured*) | 21.5 |
| Example 1 | HP92S coated | | |
| | PC film | | |
| Example 1 | PC film with | 4.4 | 1.9 |
| | Coating 7 | | |
| Example 2 | DMBPC/PC | 4.3 | 1.9 |
| | film with | | |
| | Coating 7 | | |
| Example 3 | PC film with | 2.9 | — |
| | Coating 3 | | |
| Comparative | Non-coated | 18 | — |
| Example 2 | DMBPC/PC | | |
| | film | | |
| Comparative | Non-coated | 20 | — |
| Example 3 | PC film | | |

*Post cured HP92S is as manufactured HP92S film exposed to one elliptical focused medium pressure mercury vapor lamp at 300 watt/min and conveyor speed of 20 ft/min (6.1 m/min). HP92S is designed to be post-cured to improve its Tabor and chemical resistance value; it is sold semi-cured to allow for printing on the coated surface.

### Flex Fatigue Testing

For application where the coated product will be used as where the film will be continually flexed such as in the keypads, the ability for resistance to breakage of the coated film after multiple actuations are need. All samples passed 2 million cycles of actuations, as shown in Table 10 below.

TABLE 10

| | | Flat Film/Flex Fatigue |
|---|---|---|
| No. | Description | (2 million Cycles) |
| Comparative | LEXAN ® HP92S coated PC | Pass |
| Example 1 | film | |
| Example 1 | PC film with Coating 7 | Pass |
| Example 2 | DMBPC/PC film with | Pass |
| | Coating 7 | |

### Printability

A film made is printed with a printing ink using a mesh screen. The decorated film is then thermoformed at 350 to 400° F. (177 to 204° C.) using a “zero gravity” process. This process comprises a sealed thermoformer that allows the application of positive air pressure under the film during preheating and eliminates film sagging. The decorated laminate film is dried before forming to remove the water from the polycarbonate layer. The preferred drier conditions are: 250° F. (121° C.) for 15 minutes (10 mil or 254 μm film) and 30 minutes (25 mil or 635 μm film). For an in-mold-decoration process, the thermoformed coated film are typically printed with thermally stable ink on the back of the film leaving the coated surface on the exposed side before completing the injection molding cycles. The ability for the ink to adhere to the film surfaces is measured in these tests. The samples are block screen printed at 350 mesh with inks, and the inks are then cured and checked for ink adhesion using the crosshatch test. This test follows ASTM D3002 standard methodology. The rating on this test is visual, ranging from 5 B, where all of the cut squares and edges remain intact after the crosshatch cuts and application and removal of the Permacel® tape, to 0 B, which is the lowest rating, where the coating had flaked along the edges of the cuts in large ribbons and some squares had detached partly or wholly. Two types of inks were tested, a screen printing ink and an inkjet ink. The ink used for screen printing is UV cured ink Decomold DMU® by Sun Chemicals. The ink used for digital printing on Mimaki UJF 605C® industrial digital graphic printer is Mimaki® UV inkjet ink. The results are shown in Table 11 below.

TABLE 11

| | | Screen Print | |
|---|---|---|---|
| | | (Decomold | Digital Print |
| No. | Descriptions | DMU ®) | (Mimaki ® inkjet) |
| Comparative | LEXAN ® HP92S | 5B | 5B |
| Example 1 | coated PC film | | |
| Example 1 | PC film with | 5B | 5B |
| | Coating 7 | | |
| Example 2 | DMBPC/PC film | 5B | 5B |
| | with Coating 7 | | |

In the test, printing was made on both the coated side and uncoated side of the sample. On the coated side of the samples, 5 B for adhesion was obtained for all samples printed with DMU. On the uncoated side of the samples, 5 B adhesion was obtained with all samples printed with DMU ink. On the uncoated side of the samples, 5 B adhesion was obtained with all products printed with Proell Noriphan HTR® solvent ink. On the uncoated side of samples, 5 B adhesion was obtained with all samples printed with Mimaki® inkjet. On the coated side of the samples, 2 to 3 B adhesion was obtained for HP92S and 0 B adhesion to the PC and DMBPC/PC films with coating 7 when printed with the Mimaki® inkjet.

### Chemical Resistance

Chemical resistance tests were conducted by exposing the chemicals to the film for 1 hour at 72° F. (22.2° C.) where the chemical is kept wet on the film via an upturn watch glass inserted on top of the film to be tested. Exceptions are for Spray N' Wash (Aerosol) and Salt water exposure time, which were increased to 24 hours at 72° F. (22.2° C.). Coated PC referred to as coated calendared LEXAN® ML9735 polycarbonate film using the coating formula of Example 7. Coated DMBPC/PC film referred to as coated co-extruded film of 30/70 DMX2415 and ML9735 film using Coating 7. LEXAN® HP92S PC film is current commercial coated film by Sabic Innovative Plastics using a proprietary coating formulation. The term “as manufactured” means that the film had not been exposed to any additional UV exposure apart from the coating process. The results of the testing are shown in Table 12 below. From the chemical resistance testing the formulation of Coating 7 showed excellent resistance to chemical in the as manufactured state.

TABLE 12

| | | | | | Comp. Ex. |
|---|---|---|---|---|---|
| | | Comp. Ex. 2 | Ex. 2 | Comp. Ex. 1 | 1A |
| | Ex. 1* | (Uncoated | (DMBPC/ | (HP92S | HP92S coated |
| | (PC film with | DMBPC/PC | PC with | Coated PC | PC film (post |
| Chemical | Coating 7) | film) | Coating 7) | film) | cured**) |
| Acetone | M | F | M | F | P |
| MEK | M | F | M | F | P |
| Toluene | M | F | M | F | P |
| MeCl₂ | F | F | F | F | P |
| Ethyl | M | F | M | P | P |
| Acetate | | | | | |
| Xylene | M | F | M | F | P |
| 40% NaOH | M | P | M | F | P |
| Conc. HCl | P | P | P | F | P |
| Gasoline | P | F | P | F | P |
| Butyl | P | P | P | P | P |
| Cellosolve | | | | | |
| Spray N′ | P | P | P | P | P |
| Wash | | | | | |
| (Aerosol) | | | | | |
| IPA | P | P | P | P | P |
| Salt Water | P | P | P | F | P |

*P = Pass; F = Fail; M = Slight surface demarcation.
**Post cured HP92S PC is as manufactured HP92S PC film exposed to one elliptical focused medium pressure mercury vapor lamp at 300 watt/min and a conveyor speed of 20 ft/min (6.10 m/min).

As used herein, the term “(meth)acrylate” and “acrylate” encompasses both acrylate and methacrylate groups, including in reference to both the urethane acrylate and the acrylate monomer. Ranges disclosed herein are inclusive and combinable (e.g., ranges of “up to about 25 wt %, or, more specifically, about 5 wt % to about 20 wt %”, is inclusive of the endpoints and all inner values of the ranges of “about 5 wt % to about 25 wt %,” etc.). “Combination” is inclusive of blends, mixtures, derivatives, alloys, reaction products, and so forth. Furthermore, the terms “first,” “second,” and so forth, herein do not denote any order, quantity, or importance, but rather are used to distinguish one element from another, and the terms “a” and “an” herein do not denote a limitation of quantity, but rather denote the presence of at least one of the referenced item. “Optional” or “optionally” means that the subsequently described event or circumstance can or can not occur, and that the description includes instances where the event occurs and instances where it does not. The modifier “about” used in connection with a quantity is inclusive of the stated value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and can or can not be present in other embodiments. In addition, it is to be understood that the described elements can be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A coated thermoplastic film comprising:
a polymeric film substrate; and
a coating formed from a coating composition that comprises
a urethane acrylate having a functionality of 2.5 to 6.0 acrylate functional groups; and
an acrylate monomer having at least one acrylate functional group;
wherein the coating composition is subsequently cured.

2. The coated thermoplastic film of claim 1 wherein the urethane acrylate functionality has a functionality of 2.5 to 5.5.

3. The coated thermoplastic film of claim 1 wherein the urethane acrylate has an elongation percent at break of at least 10 according to ASTM D882.

4. The coated thermoplastic film of claim 3 wherein the urethane acrylate has an elongation percent of 15 to 100.

5. The coated thermoplastic film of claim 4 wherein the urethane acrylate has a tensile strength of 1,000 to 5,000 psi and a glass transition range of 10 to 50° C.

6. The coated thermoplastic film of claim 1 wherein the urethane acrylate is an aliphatic urethane acrylate.

7. The coated thermoplastic film of claim 1 wherein the acrylate monomer is a diacrylate compound.

8. The coated thermoplastic film of claim 1 wherein the urethane acrylate is present in the amount of 20 to 90% by weight of the coating composition, and the acrylate monomer is present in the amount of 10 to 80% by weight of the coating composition.

9. The coated thermoplastic film of claim 8 wherein the coating composition further comprises a photoinitiator in the amount of 0.1 to 10% by weight of the coating composition.

10. The coated thermoplastic film of claim 1 wherein the film exhibits a Tabor Abrasion Delta Haze, as measured by ASTM D1044, of less than or equal to 5 percent, a minimum adhesion of 5 B as measured by ASTM D3002; and a pencil hardness of at least HB, as measured by ASTM D3363.

11. The coated thermoplastic film of claim 1 wherein the polymer film substrate is a polycarbonate film substrate.

12. The coated thermoplastic film of claim 11 wherein the polycarbonate film substrate is a co-extruded multilayer film comprising:
a first layer comprising a blend of polycarbonate comprising repeat units of dimethyl bisphenol cyclohexane monomer and a polycarbonate comprising repeat units of bisphenol A; and
a second layer comprising a polycarbonate comprising repeat units of bisphenol A without polycarbonate comprising repeat units of dimethyl bisphenol cyclohexane monomer;
wherein the film exhibits a Tabor Abrasion Delta Haze, as measured by ASTM D1044, of less than or equal to 5 percent, a minimum adhesion of 5 B as measured by ASTM D3002; and a minimum pencil hardness of HB, as measured by ASTM D3363.

13. The coated thermoplastic film of claim 1 wherein the polycarbonate film substrate is 25 to 1500 micrometers thick, and the coating is 1 to 50 micrometers thick.

14. The thermoplastic film of claim 11 made by a process comprising applying the coating composition onto a moving web of the polycarbonate film substrate, nipping the wet coating between a smooth metal casting roll and a elastomeric roll and, while the coated film is in contact with the casting roll, exposing the coating to UV energy to activate polymerization of the coating, wherein the casting roll temperature is 71.1 to 93.0° C.

15. A coated thermoplastic film comprising:
A coated thermoplastic film comprising:
a polycarbonate film substrate; and
a coating formed from a coating composition that comprises
a urethane acrylate having a functionality of 2.5 to 5.5 acrylate functional groups, wherein the urethane acrylate has an elongation percent at break of at least 10 according to ASTM D882;
an acrylate monomer having at least two acrylate functional groups;
wherein the urethane acrylate is present in the amount of 20 to 90% by weight of the coating composition, the acrylate monomer is present in the amount of 10 to 80% by weight of the coating composition, and a photoinitiator is present in the amount of 0.1 to 10% by weight of the coating composition;
wherein the coating composition has been cured at a temperature of 71.1 to 93.0° C.; and
wherein the film substrate is a co-extruded multilayer film substrate comprising
a first layer, on which the coating is applied, comprising a blend of a first polycarbonate that comprises repeat units of dimethyl bisphenol cyclohexane monomer and a second polycarbonate that comprises repeat units of bisphenol A; and
a second layer, adjacent to the first layer, comprising a polycarbonate that comprises repeat units of bisphenol A, without a polycarbonate that comprises repeat units of dimethyl bisphenol cyclohexane monomer;
wherein the film exhibits a Tabor Abrasion Delta Haze, as measured by ASTM D1044, of less than or equal to 5 percent, a minimum adhesion of 5 B as measured by ASTM D3002; and a pencil hardness of at least HB, as measured by ASTM D3363.

16. A molded article comprising the coated thermoplastic film of claim 1, wherein the film is subjected to printing to obtain a decorative film, in combination with an injection molded polymeric base structure to which the printed film is bonded, and wherein the coated polymeric film has been formed into a non-planar three-dimensional shape matching a three-dimensional shape of the injection molded polymeric base structure.

17. A method of molding an article, comprising decorating and shaping the coated thermoplastic film according to claim 1 and placing the film into a mold, and injecting a resin into the mold cavity space behind the film, wherein said film and said injection molded resin form a single molded part.

18. A method of molding according to claim 17 comprising printing a surface of the coated thermoplastic film opposite the coating with markings to obtain a decorative film; forming and trimming the decorative film into a non-planar three-dimensional shape; fitting the decorative film into the mold having a surface that matches the non-planar three-dimensional shape of the decorative film; and injecting a substantially transparent resin comprising a polycarbonate resin into the mold cavity behind the decorative film to produce a one-piece, permanently bonded non-planar three-dimensional product.
